(19) United States
(12) Patent Application Publication
(10) Pub. No.: US 2025/0375045 A1
(43) Pub. Date: Dec. 11, 2025

(54) AN INFLATABLE PRODUCT

(71) Applicant: Intex Marketing Ltd., Tortola (VG)

(72) Inventors: Zhi Xiong Huang, Fujian (CN); Ying Biao Zhang, Fujian (CN); Zhi Wen Zhou, Fujian (CN)

(73) Assignee: Intex Marketing Ltd., Tortola (VG)

(21) Appl. No.: 19/127,835

(22) PCT Filed: Dec. 18, 2023
(86) PCT No.: PCT/IB2023/062896

§ 371 Date: May 7, 2025

(30) Foreign Application Priority Data
Dec. 19, 2022 (CN) 202223406801.7

(51) Int. Cl. A47C 27/10; A47C 7/74; A47C 27/08; A61H 9/00

(52) U.S. Cl. CPC A47C 27/10; A47C 7/748; A47C 27/081; A61H 9/0078; A61H 2201/0142; A61H 2201/0207; A61H 2201/0221; A61H 2201/1246

(57) ABSTRACT

An inflatable product may comprise a first panel, a second panel, an intermediate panel positioned between the first panel and the second panel, a cushion, and an enclosure panel coupled to the first panel and the second panel. The first panel, the intermediate panel, and the enclosure panel may cooperate to form a first chamber. The intermediate panel, the second panel, and the enclosure panel may cooperate to form a second chamber. The cushion may be positioned within the first chamber. The intermediate panel may include an air hole fluidly connecting the first chamber and the second chamber. A first side of the cushion may be coupled to the first panel.

### RELATED APPLICATIONS

This application is related to Chinese Application No. CN202223406801.7, filed Dec. 19, 2022, the entire disclosure of which is expressly incorporated herein by reference.

### FIELD OF THE DISCLOSURE

The present disclosure relates to the field of inflatable products, and particularly to an inflatable bed.

### BACKGROUND OF THE DISCLOSURE

Inflatable products, such as an inflatable bed, are easy to use, light weight, easily transportable, and easily storable. Further, inflatable beds are quite suitable for use as a temporary or non-fixed bed body.

An inflatable bed may include one or more air chambers. However, an inflatable bed that depends solely on the one or more air chambers and the air pressure therein to support the user may not provide the user with the desired comfort. If the air pressure is low when in use, the bed body may shake, and if the air pressure is high, the bed body may affect comfort. Therefore, some inflatable beds have added a sponge cushion. Specifically, the inflatable bed includes a top sheet, an intermediate sheet, a bottom sheet and an enclosure sheet to form an upper air chamber and a lower air chamber, and a sponge cushion is arranged in the upper air chamber to improve the comfort of the inflatable bed. However, the sponge cushion is not connected to the top sheet, and when the air pressure of the inflatable bed is high, an air layer may form between the upper face of the sponge cushion and the top sheet, which will adversely affect the comfort of the inflatable bed.

### SUMMARY OF THE DISCLOSURE

In embodiments, the present disclosure may provide an inflatable product, such as an inflatable bed, with improved comfort.

In one form thereof, an inflatable product may comprise a first panel, a second panel, an intermediate panel positioned between the first panel and the second panel, a cushion, and an enclosure panel coupled to the first panel and the second panel. The first panel, the intermediate panel, and the enclosure panel may cooperate to form a first chamber. The intermediate panel, the second panel, and the enclosure panel may cooperate to form a second chamber. The cushion may be positioned within the first chamber. The intermediate panel may be provided with an air hole fluidly connecting the first chamber and the second chamber. A first side of the cushion may be coupled to the first panel.

In another form thereof, the inflatable product may further comprise a heating wire arranged between the cushion and the first panel.

In another form thereof, the inflatable product may further comprise a massage group arranged in the first chamber and positioned adjacent to the cushion.

In another form thereof, the massage group may comprise a plurality of massage air chambers and a massage pump connected to the massage air chambers.

In another form thereof, a length, width, and height of the cushion may be the same as a length, width, and height of the first chamber.

In another form thereof, the inflatable product may further comprise a tensioning structure arranged within the second chamber. A first end of the tensioning structure may be coupled to the intermediate panel, and a second end of the tensioning structure may be coupled to the second panel.

In another form thereof, the inflatable product may further comprise a first oblique tensioning structure arranged within the second chamber and a second oblique tensioning structure arranged within the second chamber. One end of the first oblique tensioning structure may be coupled to the intermediate panel and another end may be coupled to the enclosure panel. One end of the second oblique tensioning structure may be coupled to the enclosure panel and another end may be coupled to the second panel.

In another form thereof, the first side of the cushion may be coupled to the first panel with adhesive.

In another form thereof, when the inflatable product is deflated, the intermediate panel may contact the second panel.

In another form thereof, when the inflatable product is inflated, the intermediate panel may be spaced apart from the second panel by a distance, and the tensioning structure may span the distance between the intermediate panel and the second panel.

One advantage, among others, is that the cushion is fitted or coupled to the first panel of the inflatable product. Thus, even if the second chamber is at a relatively high air pressure, the cushion remains close to the first panel, and no air layer is formed. The user may directly feel the cushion when lying on the inflatable bed. The inflatable bed may thus provide comfort while also maintaining a sufficiently high internal air pressure to reduce shaking of the bed body. Because the first and second chambers are in fluid communication, when the second chamber of the inflatable bed is deflated, the first chamber may also be deflated, and the cushion may be compressed to reduce the storage volume of the inflatable bed.

Advantageously, an optional heating wire and an optional massage group, alone or in combination, may further improve the comfort of the inflatable product.

Additional features and advantages of the present disclosure will become apparent to those skilled in the art upon consideration of the following description.

### BRIEF DESCRIPTION OF THE DRAWINGS

FIG. 1 is an exploded view of an exemplary inflatable product according to the present disclosure;

FIG. 2 is a partial section view of the inflatable product of FIG. 1;

FIG. 3 is an exploded view of another exemplary inflatable product according to the present disclosure;

FIG. 4 is an exploded view of another exemplary inflatable product according to the present disclosure;

FIG. 5 is an exploded view of another exemplary inflatable product according to the present disclosure;

FIG. 6 is a perspective view of an exemplary tensioning structure of the present disclosure;

FIG. 7 is a cross-sectional view of an exemplary tensioning structure of the present disclosure;

FIG. 8 is a cross-sectional view of an exemplary inflatable product depicted in an inflated state; and

FIG. 9 is a cross-sectional view of an exemplary inflatable product depicted in a partially deflated state.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure.

### DETAILED DESCRIPTION OF THE EMBODIMENTS

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

In the description of the present disclosure, it should be noted that the terms “up”, “down”, “inside”, “outside”, “top/bottom”, etc. indicate the orientation or position relationship based on the orientation or position relationship shown in the attached drawings, only for the convenience of describing the present disclosure and simplifying the description, rather than indicating or implying that the device or component referred to must have a specific orientation, or be constructed and operated in a specific orientation. Therefore, it cannot be understood as a limitation on the present disclosure. In addition, the terms “first” and “second” are only used to describe and cannot be understood as indicating or implying relative importance.

In the description of the present disclosure, it should be noted that unless otherwise specified and limited, the terms “installation”, “set with”, “set/connected”, “connected”, etc. should be understood broadly. For example, “connected” can be a wall mounted connection, a detachable connection, or an integrated connection, can be a mechanical connection, can be an electrical connection, can be directly connected, or can be indirectly connected through an intermediate medium, can be the internal connection between two components, and for ordinary technical personnel in this field, the specific meaning of the above terms in the present disclosure can be understood in a specific situation.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

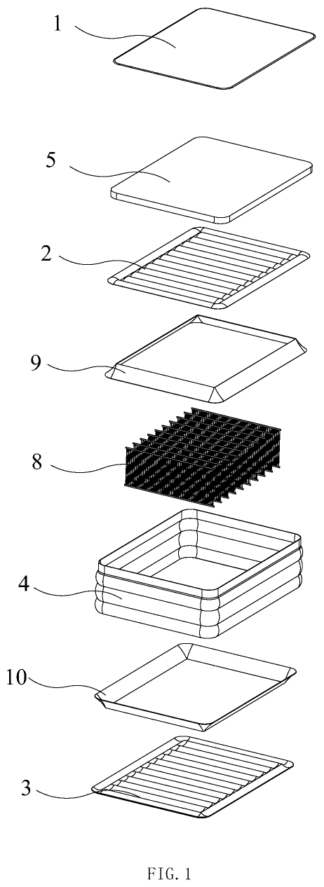

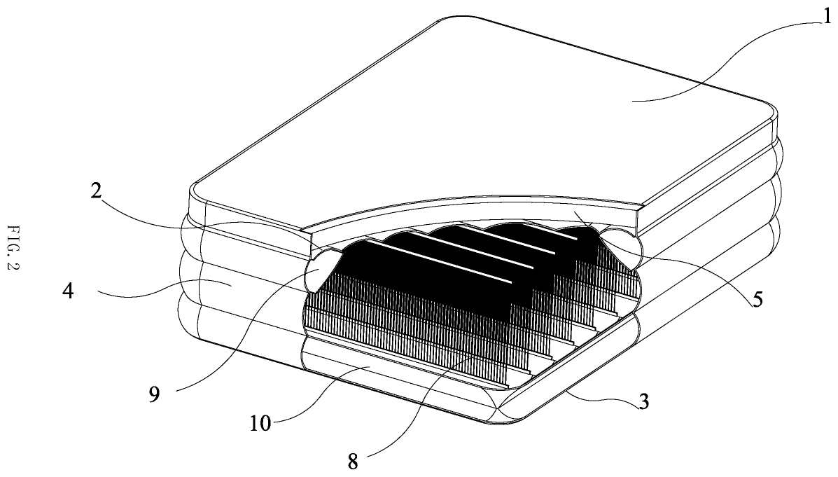

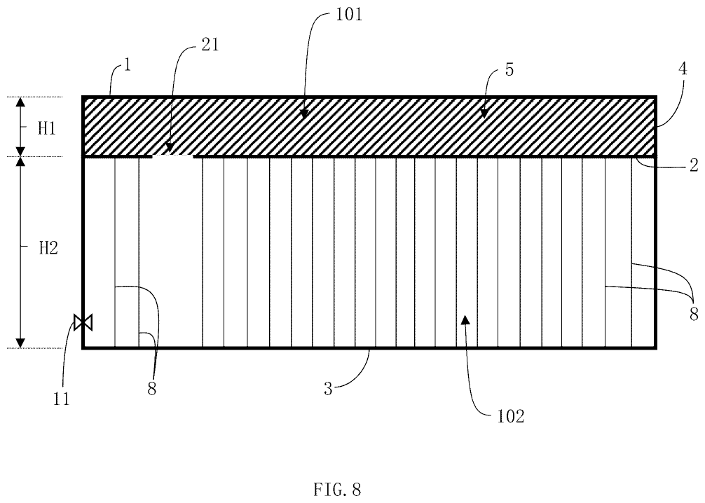

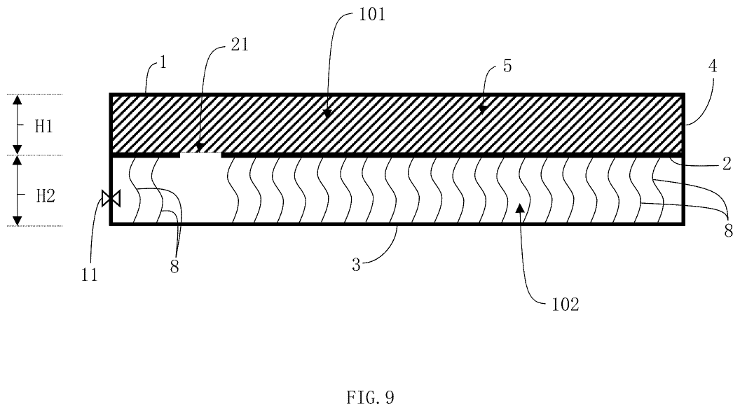

As shown in FIG. 1 and FIG. 2, the disclosure provides an inflatable product, illustratively an inflatable bed, which comprises a first panel 1, an intermediate panel 2, a second panel 3, and an enclosure panel 4. First panel 1, intermediate panel 2, and enclosure panel 4 may cooperate to form a first chamber 101 (FIGS. 8 and 9), and intermediate panel 2, second panel 3, and enclosure panel 4 may cooperate to form a second chamber 102 (FIGS. 8 and 9). As shown in FIG. 1, for example, the inflatable product may further include a cushion 5, such as a sponge cushion, which may be arranged in first chamber 101 formed by first panel 1, intermediate panel 2, and enclosure panel 4. Exemplary cushions may include any material which may be compressed under an external force and which rebounds towards its original form in the absence of the external force. An air hole 21 (FIGS. 8 and 9) fluidly connecting first chamber 101 and second chamber 102 may be provided on the intermediate panel 2. A first side of cushion 5 may be fitted with or coupled to the first panel 1 such that cushion 5 and first panel 1 abut. The coupling of cushion 5 to first panel 1 may be achieved by gluing with an adhesive, stitching, mechanical securement (such as hook and loop fasteners or a pocket) or other suitable means.

Before use, second chamber 102 is inflated. To facilitate inflation of first chamber 101 and second chamber 102, enclosure panel 4 includes a valve 11 (FIGS. 8 and 9) for fluidly connecting to an air pump. To avoid shaking the inflatable product, second chamber 102 maintains high air pressure. As the cushion 5 and the first panel 1 are coupled to one another, even if second chamber 102 is at high pressure, the cushion 5 abuts first panel 1, avoiding formation of an air layer between cushion 5 and first panel 1. When the user lies on the inflatable bed, the user can directly feel cushion 5. Therefore, the inflatable bed can improve comfort while maintaining the requisite internal air pressure needed to reduce shaking or undesired movement or deformation of the bed body. After use, the air inside the inflatable bed may be extracted to deflate the inflatable bed. Because first and second chambers 101, 102 are fluidly connected via hole 21 in intermediate panel 2, the air in first chamber 101 will also be extracted during deflation of second chamber 102. Cushion 5 may be compressed, thereby reducing the storage volume of the inflatable bed. In an inflated state, first chamber 101 may have a height H1 and second chamber 102 may have a height H2 greater than height H1 (FIG. 8). As the inflatable product is deflated, height H2 decreases (FIG. 9). Once the inflatable product is fully deflated, intermediate panel 2 may contact second panel 3. Further, as provided above, the user may compress cushion 5, thereby reducing the storage volume of the inflatable bed in the deflated state.

To help maintain the inflatable bed in the desired configuration or position, the length, width, and height of the cushion 5 may be the same as the length, width, and height of first chamber 101, respectively.

In embodiments, second chamber 102 may be provided with a tensioning structure 8, a first end of which may be coupled to the intermediate panel 2, and a second end of which may be coupled to the second panel 3. Second chamber 102 may be further provided with a first oblique tensioning structure 9 and a second oblique tensioning structure 10. One end of the first oblique tensioning structure 9 may be coupled to the intermediate panel 2, and the other end of the first oblique tensioning structure 9 may be coupled to the enclosure panel 4. One end of the second oblique tensioning structure 10 may be coupled to the enclosure panel 4, and the other end of the second oblique tensioning structure 10 may be coupled to the second panel 3.

Exemplary tensioning structures which may be implemented for any of the tensioning structures disclosed herein, such as tensioning structure 8, first oblique tensioning structure 9, or second oblique tensioning structure 10, are disclosed in U.S. Pat. No. 10,165,869 and PCT Published Application No. PCT/US2023/025268, filed Jun. 14, 2023, the entire disclosures of which are expressly incorporated herein by reference.

An exemplary tensioning structure in accordance with the present disclosure utilizes thin and flexible string or wire-like strands to join two members, such as intermediate panel 2 and second panel 3, to one another. The strands are firmly coupled to the adjacent members, such as intermediate panel 2 and second panel 3, via an intermediate material, such as a strip or sheet, and the intermediate material is in turn firmly coupled to the adjacent members. The area of contact between the intermediate material and the attached strands may be manipulated to impart a connection strength commensurate with the tensile strength of the strand. Similarly, area of contact between the intermediate material and the adjacent member may also be manipulated to impart a member/tensioning structure connection strength commensurate with the aggregate tensile strength of all strands in the tensioning structure.

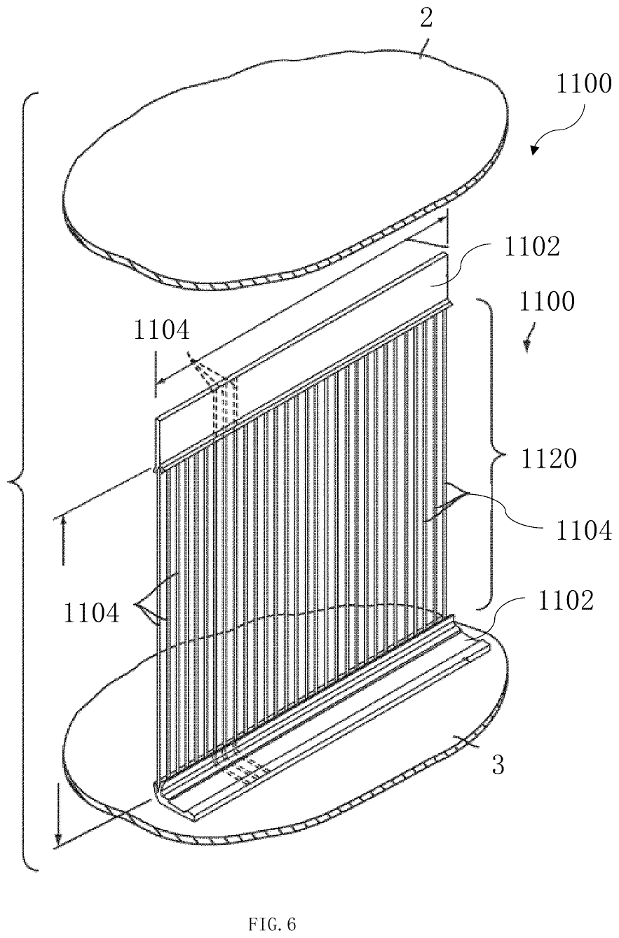

Turning now to FIG. 6, tensioning structure 1100 is shown joining intermediate panel 2 and second panel 3. In the illustrated embodiment, tensioning structure 1100 includes first and second weld strips 1102 connected to one another by a plurality of substantially parallel strands 1104 that define a gap portion extending between a gap 1120 between intermediate panel 2 and second panel 3. First and second weld strips 1102 are in turn welded to the intermediate panel 2 and second panel 3, respectively, such that forces urging intermediate panel 2 and second panel 3 apart are countered by tension in strands 1104.

Optionally, reinforcing strands (not shown) may be provided along the longitudinal extent of weld strip 1102, i.e., substantially perpendicular to strands 1104. Reinforcing strands, when provided, may be coupled to tensile strands 1104, such as by folding strands 1104 over reinforcing strands, tying reinforcing strands and strands 1104 to one another, or adhesively securing reinforcing strands and strands 1104 to one another.

The plurality of strands 1104 in the tensioning structure 110 as shown in FIG. 6 are arranged such that the strands 1104 are substantially parallel to one another when strands 1104 are pulled taut, i.e., when weld strips 1102 are drawn away from one another represented by spacing or gap 1120. Additionally, adjacent pairs of strands 1104 may have even intervals therebetween, such that a substantially constant tensile strength of tensioning structure 1100 is maintained across the longitudinal extent of weld strips 1102. In an exemplary embodiment, strands 1104 may extend along the entire width of weld strips 1102, as illustrated in FIG. 6, such that a large area of contact between strands 1104 and weld strips 1102 is achieved. For clarity, FIG. 6 illustrates only a limited number of strands 1104 affixed to strips 1102 in this way, it being appreciated that all strands 1104 in tensioning structure 1100 may be so affixed.

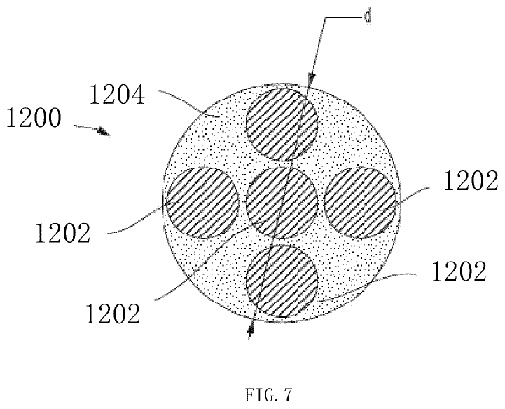

Turning to FIG. 7, a cross-section of an exemplary strand 1200, which may be used in tensioning structure 1100, is shown. Each strand 1200 may be a multifilament structure including at least two (illustratively, five) filaments 1202. Each filament 1202 may itself contain multiple filament yarns. Filament 1202 may be twisted into a cable-like structure and may further include a binder or adhesive layer 1204, which retains an intended configuration of filaments 1202 relative to one another, and which aids in fixation of strands 1200 to strips 1102. The filaments 1202 may define a weight of 50 Decitex (dtex), it being understood that dtex is defined as the mass of strand 1200 in grams per 10,000 meters of strand 1200. The filaments 1202 may be no greater than 1,000 dtex. Each strand 1200 may have a denier of at least 50 D, it being understood that denier is the mass of filament 1202 in grams per 9,000 meters of filament 1202. The denier of each strand 1200 may be no greater than 2,500 D. The overall diameter d (shown, e.g., in FIG. 7) of strand 1200 may be at least 0.10 mm and no greater than 0.14 mm. Additional details regarding exemplary strands and attachment structures, such as weld strips or weld sheets, are disclosed in PCT Published Application No. PCT/US2023/025268, the disclosure of which is expressly incorporated herein by reference herein.

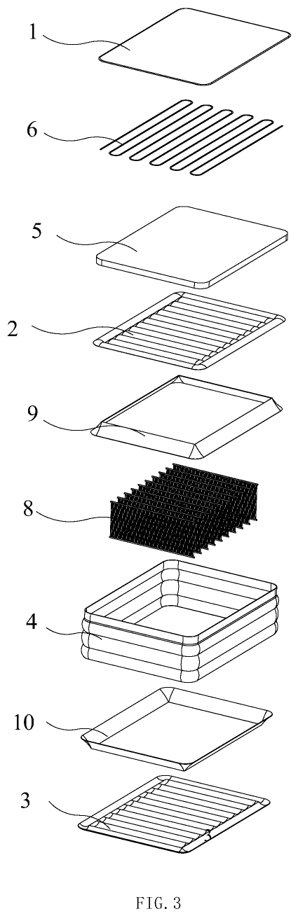

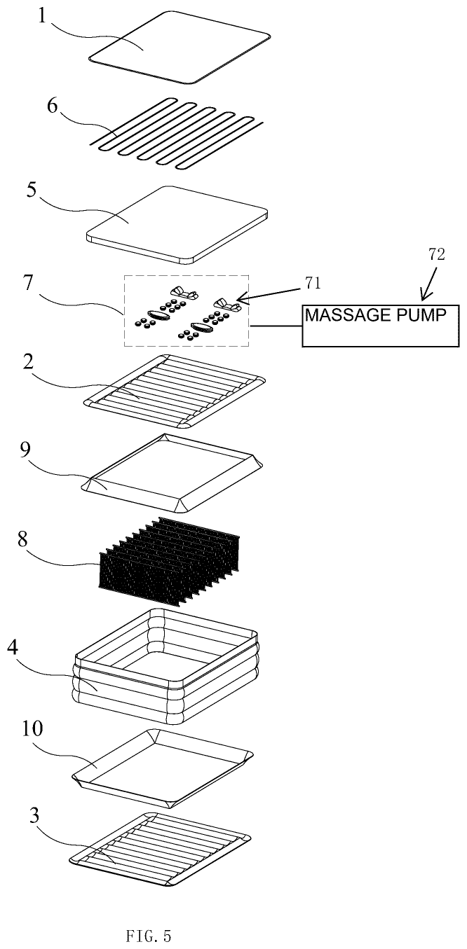

Returning to FIGS. 3 and 5, to further improve the comfort of the inflatable bed, the inflatable bed may be further provided with a heating wire 6, which, in the illustrated embodiment, is arranged between cushion 5 and the first panel 1. Heating wire 6 may realize the heating and cooling of the inflatable bed, and the user may choose whether to heat or cool according to their own needs, so as to improve the comfort of the inflatable bed. Heating wire 6 may be connected to an external power supply (not shown).

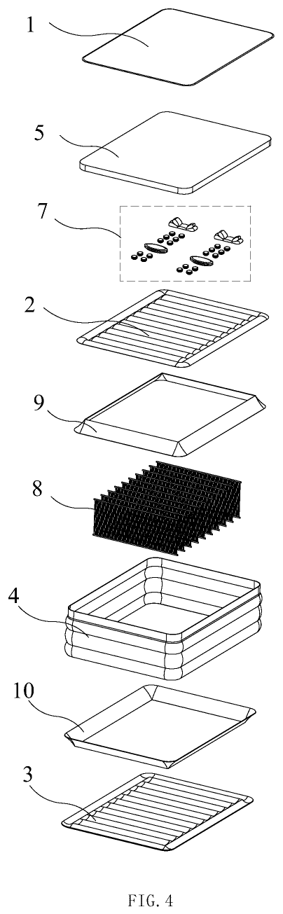

Additionally, referring to FIGS. 4 and 5, the inflatable bed may be further provided with a massage group 7, which may be positioned in first chamber 101 and, as shown in in the illustrated embodiment, under cushion 5. As shown in FIG. 4, massage group 7 may be set separately on an inflatable bed, and the inflatable bed may have the massage function while improving the comfort of use through cushion 5. As shown in FIG. 5, massage group 7 may also be arranged on the inflatable bed together with heating wire 6. Thus, the inflatable bed not only improves the comfort of use through cushion 5 but may also have the massage function and heating and cooling function of massage group 7 and heating wire 6, respectively.

Massage air chamber group 7 may comprise a plurality of massage air chambers 71 and a massage pump 72 connected to the plurality of massage air chambers 71. The massage pump 72 inflates different massage chambers 71 to massage different parts of the user.

### EXAMPLES

Example 1: An inflatable product may comprise a first panel, a second panel, an intermediate panel positioned between the first panel and the second panel, a cushion, and an enclosure panel coupled to the first panel and the second panel. The first panel, the intermediate panel, and the enclosure panel may cooperate to form a first chamber. The intermediate panel, the second panel, and the enclosure panel may cooperate to form a second chamber. The cushion may be positioned within the first chamber. The intermediate panel may include an air hole fluidly connecting the first chamber and the second chamber. A first side of the cushion may be coupled to the first panel.

Example 2: The inflatable product according to Example 1 may further comprise a heating wire, which may be arranged between the cushion and the first panel.

Example 3: The inflatable product according to any one of Examples 1 and 2 may further comprise a massage group, which may be arranged in the first chamber and may be positioned adjacent to the cushion.

Example 4: The inflatable product according to Example 3, wherein the massage group may comprise a plurality of massage air chambers and a massage pump connected to the massage air chambers.

Example 5: The inflatable product according to any one of Examples 1-4, wherein a length, width, and height of the cushion may be the same as a length, width, and height of the first chamber.

Example 6: The inflatable product according to any one of the Examples 1-5 may further comprise a tensioning structure, which may be arranged within the second chamber. A first end of the tensioning structure may be coupled to the intermediate panel, and a second end of the tensioning structure may be coupled to the second panel.

Example 7: The inflatable product according to any one of Examples 1-6 may further comprise a first oblique tensioning structure, which may be arranged within the second chamber, and a second oblique tensioning structure, which may be arranged within the second chamber. One end of the first oblique tensioning structure may be coupled to the intermediate panel and another end of the first oblique tensioning structure may be coupled to the enclosure panel. One end of the second oblique tensioning structure may be coupled to the enclosure panel and another end may be coupled to the second panel.

Example 8: The inflatable product according to any one of Examples 1-7, wherein the first side of the cushion may be coupled to the first panel with adhesive.

Example 9: The inflatable product according to any one of Examples 1-8, wherein, when the inflatable product is deflated, the intermediate panel may contact the second panel.

Example 10: The inflatable product according to Example 6, wherein, when the

inflatable product is inflated, the intermediate panel may be spaced apart from the second panel by a distance, and the tensioning structure may span the distance between the intermediate panel and the second panel.

### REFERENCE NUMERALS

First panel 1; Intermediate panel 2; Second panel 3; Enclosure panel 4; Cushion 5; Heating wire 6; Massage group 7; Tensioning structure 8; First oblique tensioning structure 9; Second oblique tensioning structure 10; Valve 11; Plurality of massaging air chambers 71; Massage pump 72; First chamber 101; Second chamber 102; 1100 Tensioning structure; 1102 Weld strip; 1104 Strand; 1120 Gap; 1200 Strand; 1202 Filament; 1204 Adhesive or binder; H1 Height of first chamber; H2 Height of second chamber.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

1. An inflatable product comprising:
a first panel,
a second panel,
an intermediate panel positioned between the first panel and the second panel,
a cushion, and
an enclosure panel coupled to the first panel and the second panel; the first panel, the intermediate panel, and the enclosure panel cooperate to form a first chamber, the intermediate panel, the second panel, and the enclosure panel cooperate to form a second chamber, the cushion is positioned within the first chamber, wherein the intermediate panel includes an air hole fluidly connecting the first chamber and the second chamber, and a first side of the cushion is coupled to the first panel.

2. The inflatable product of claim 1, further comprising a heating wire arranged between the cushion and the first panel.

3. The inflatable product of claim 1, further comprising a massage group arranged in the first chamber and positioned adjacent to the cushion.

4. The inflatable product of claim 3, wherein the massage group comprises a plurality of massage air chambers and a massage pump connected to the massage air chambers.

5. The inflatable product of claim 1, wherein a length, width, and height of the cushion are the same as a length, width, and height of the first chamber.

6. The inflatable product of claim 1, further comprising a tensioning structure arranged within the second chamber, a first end of the tensioning structure is coupled to the intermediate panel, and a second end of the tensioning structure is coupled to the second panel.

7. The inflatable product of claim 1, further comprising a first oblique tensioning structure arranged within the second chamber and a second oblique tensioning structure arranged within the second chamber, wherein one end of the first oblique tensioning structure is coupled to the intermediate panel and another end of the first oblique tensioning structure is coupled to the enclosure panel, and wherein one end of the second oblique tensioning structure is coupled to the enclosure panel and another end is coupled to the second panel.

8. The inflatable product of claim 1, wherein the first side of the cushion is coupled to the first panel with adhesive.

9. The inflatable product of claim 1, wherein, when the inflatable product is deflated, the intermediate panel contacts the second panel.

10. The inflatable product of claim 6, wherein, when the inflatable product is inflated, the intermediate panel is spaced apart from the second panel by a distance, and the tensioning structure spans the distance between the intermediate panel and the second panel.
